(19) United States
(12) Patent Application Publication
(10) Pub. No.: US 2009/0077218 A1
(43) Pub. Date: Mar. 19, 2009

(54) Software Method And System For Controlling And Observing Computer Networking Devices

(75) Inventor: Gary Ray Johnson, Roswell, GA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: softKVM LLC, Roswell, GA (US)

(21) Appl. No.: 12/210,008

(22) Filed: Sep. 12, 2008

Related U.S. Application Data
(60) Provisional application No. 60/972,566, filed on Sep. 14, 2007.

(51) Int. Cl. G06F 15/16; G06F 9/445

(52) U.S. Cl. 709/223; 713/2

(57) ABSTRACT

Mechanisms for managing the keyboard, video or mouse commands at a target device, which may be a computer or non-computer. During a boot up cycle, the present subject matter uses the intelligent platform management interface and a BIOS management application to receive keyboard or video signals from the BIOS, convert the signals to internet protocol format, and transmit those signals to a managing computer. Controls signals may be transmitted from the managing computer to the target device. After the boot up cycle, the target device may be configured to cause the management of the computer to be transferred from the BIOS management application to an operating system management application. During normal operation, the operating system management application provides for the ability to receive at the target computer keyboard, video or mouse signals and to transmit to the managing computer keyboard, video or mouse signals generated at the target device.

### RELATED APPLICATIONS

This application claims benefit of U.S. Provisional Application No. 60/972,566, entitled, “Software Method and System for Controlling and Observing Computer Networking Devices”, filed Sep. 14, 2007 (Docket No. SKVM-0002), the entire contents of which are hereby incorporated herein by reference. This application is related by subject matter to the subject matter disclosed in the following commonly assigned application, the entirety of which is hereby incorporated by reference herein: U.S. patent application Ser. No. ______ (Docket No. SKVM-0007), filed on ______ and entitled “Controlling and Observing Computing Network Devices.”

### FIELD OF TECHNOLOGY

The presently disclosed subject matter relates to the field of computing, and more particularly, to the monitoring and/or controlling of computing network devices.

### BACKGROUND

As corporate and governmental computer networks have expanded, there has been an increasing need for keyboard, video, and mouse (KVM) switches that can monitor and manage large numbers of computer network devices (CND) (servers, computers, etc.) from local and remote user workstations. In the current art, KVM switches are deployed over industry standard networks, such as a TCP/IP network. KVM switches that utilize a packet switched network (PSN) are commonly known as KVM over internet protocol (IP) switches. In one example of an implementation currently used, a KVM switch that is accessed via an IP network is generally attached to the computer to be monitored/managed, or a target computer, either by a KVM cable or a converter/transmit device that provides the interface between the target computer and the KVM switch. There may be other ways in which the target computer is monitored/managed during various phases of operation, such as a boot cycle, operating cycle, and troubleshooting cycle.

### SUMMARY

During a boot up cycle, a target device may be managed. The management of the target device may be either monitoring one or more outputs of the target device and/or sending command signals to the target device. One or more target devices may be managed by one or more managing computers. The target device may be a computer, which may be the target computer, or a non-computer.

In one example, a BIOS boot up cycle is commenced along with the initiation of a monitoring and/or management interface, such as an intelligent management platform interface. A BIOS management application is commenced. An output packet, which may be received by the BIOS management application from the intelligent management platform interface, is converted to a communication protocol.

In some examples, the communication protocol used may be an internet protocol format for transmission of the output packet over a TCP/IP connection. The converted output packet is transmitted to a managing computer. In some examples, the output packet may be related to a video output, sensor data or a keyboard input. Some examples of sensor data include, but are not limited to, a temperature or a fan speed. The output packet may be received at and displayed on the managing computer. The managing computer may also be configured to transmit to the target device an input packet.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects shown. The following figures are included:

FIG. 1 is an exemplary system in which a managing computer may manage a target computer;

FIG. 2 is an exemplary system in which a managing computer may manage a target computer during a boot up cycle;

FIG. 3 is an exemplary and non-limiting method of managing a target computer during a boot up cycle;

FIG. 4 is an exemplary and non-limiting method of receive an input signal at a target computer during a boot up cycle;

FIG. 5 is an exemplary and non-limiting example of a method of transferring control from the boot up cycle to the steady state, or operating, condition;

FIG. 6 is an exemplary method of the present subject matter describing a communication link during the boot up cycle;

FIG. 7 is an exemplary method illustration how TCCS, MCCS and UCCS may change their process (es) at the end of the target computer's boot up process (es);

FIG. 8 is an exemplary method that illustrates how the MCCS and UCCS communicate with a target non-computer during its boot up process(es);

FIG. 9 is an exemplary method that illustrates how MCCS and UCCS change their communication process(es) with the target non-computer at the end of its boot up process(es);

FIG. 10 is an exemplary method in which a UCCS may establish data input access to a target computer in its post boot up process(es);

FIG. 11 is an exemplary method in which a UCCS may establish no data input access to a target computer in its post boot up process(es);

FIG. 12 is an exemplary method in which a TCCS prepares the target computer's data output for transmission to UCCS in the target computer's post boot up process(es);

FIG. 13 is an exemplary method describing how the MCCS and UCCS communicate with the TCCS during the target computer's post boot up process(es);

FIG. 14 is an exemplary method describing how a UCCS terminates communication with the target computer;

FIG. 15 is an exemplary method describing how a UCCS establishes data input access to a target non-computer that is in its post boot up process(es);

FIG. 16 is an exemplary method describing how a UCCS establishes no data input access to a target non-computer that is in its post boot up process(es); and

FIG. 17 is an exemplary method describing how a UCCS terminates communication with the target non-computer that is in its post boot up process(es).

### DETAILED DESCRIPTION

The subject matter of the various embodiments is described with specificity to meet statutory requirements. However, the description itself is not intended to limit the scope of this patent. Rather, the inventor has contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are only exemplary. The following description is illustrative and non-limiting to any one aspect.

The present subject matter involves a method for the management and/or monitoring of one or more local and/or remote target computers. The present subject matter also involves a method of management or monitoring, at one or more managing computers, one or more target non-computers via an integrated software application program that utilizes shared database(s) throughout the computer's and non-computer's boot up processes and post boot up operations. Therefore, the use of a singular or plural “computer” or “non-computer” may be interpreted as being one or more than one, and thus, should not be interpreted as a limitation on the scope of the present subject matter.

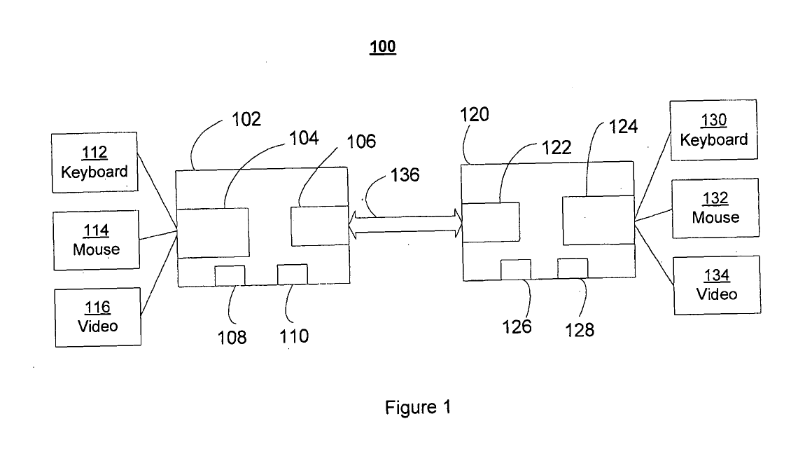

The present subject matter may provide a user with the ability to monitor and control, or manage: a computer to be managed, or the “target” computer; inputs to the target computer, such as, but not limited to, a keyboard, video or mouse; or a non-computer, such as, but not limited to, a serial console, a power distribution unit, or a network router. FIG. 1 is illustrative of an exemplary system configured according to an exemplary embodiment of the present subject matter. System 100 comprises two computers, managing computer 102 and target computer 120. It should be understood that the number of computers, either managing or target, is exemplary only, and that the present subject matter may be used to manage multiple target computers by one or more managing computers. Further, it should be understood that a computer may include, but is not limited to, a server computer or a client computer.

Managing computer 102 has processor 108 which executes instructions that are stored in computer-readable storage medium 110. It should be understood that computer-readable storage medium 110 may include, but is not limited to, one or more memory units installed on managing computer 102 or portable computer-readable storage medium, such as a compact disc. Managing computer 102 also has management application 104, which converts inputs received from keyboard 112, mouse 114 and video 116 to a format for output to target computer 120 through communication interface unit 106, which may be a combined input/output interface, an input interface and an output interface, or one or more input or output interfaces.

To communicate with target computer 120, communication link 136 is established. Communication link 136 may vary, but in one example, may include a communication link established over the Internet, wherein the communications transmitted through communication link 136 are, in one example, an internet protocol format such as TCP/IP. To receive communications from managing computer 102 and to transmit data packets to managing computer 102, target computer 120 may have communication interface 122, which receives data packets in internet protocol format, for example, from managing application 124. Managing application 124 receives input from and transmits commands to various devices, such as keyboard 130, mouse 132 and video unit 134. It should be understood that devices 130-134 may be communicatively connected to target computer 120 in various ways, the subject matter of the present application not limited to any particular manner.

Target computer 120 may also have processor 126 configured to execute instructions and computer-readable storage medium 128. It should be understood that computer-readable storage medium 128 may include, but is not limited to, one or more memory units installed on target computer 120 or portable computer-readable storage medium, such as a compact disc. In operation, managing application 124 receives inputs from devices 130-134 and converts those inputs into an appropriate format, such as an internet protocol format. The inputs are transmitted from target computer 120 via communication interface 122, communication link 136 to communication interface 106 of managing computer 102. Once received at managing computer 102, the inputs are converted to an appropriate format for use by managing application 104. The converted inputs may then be displayed for use using various devices, such as video device 116.

During a boot up cycle, a target computer typically does not have all communication and operating systems executing when compared to a target computer that is running off the target computer's operating system. This may facilitate the need to provide for an additional monitoring capability. Further, because a boot up cycle is not a steady state operation, once the boot up cycle is complete, the present invention provides for the ability to transfer control from a managing program used during the boot up cycle to a managing program for use in steady state, or operating, conditions.

In one example, a target computer may boot up using motherboard control software firmware (MCSF). In this instance, the MCSF may be required to provide input from and control data packets to devices, such as the video device and data input. Typically, the MCSF is resident on the target computer's motherboard at the start of the boot up process. The MCSF is typically initiated from the target computer's BIOS or other firmware resident on the motherboard at the initiation of the target computer's boot up process.

The transmitting MCSF will initiate the transfer of the target computer's video data output to one or more local and/or remote separate computer(s) and/or non-computer(s) (including but not limited to display units). The video data from the target computer may be securely transferred to the separate computer(s) and non-computer(s) in a variety of communication methods, including but not limited to a TCP/IP compatible network and serial data stream. In certain systems, there is provided an intelligent platform management interface (IPMI). The IPMI typically commences execution at the same time that the target computer's BIOS commences execution. In the present subject matter, the IPMI may be used to capture data packets, such as a video output and status values from the target computer's motherboard.

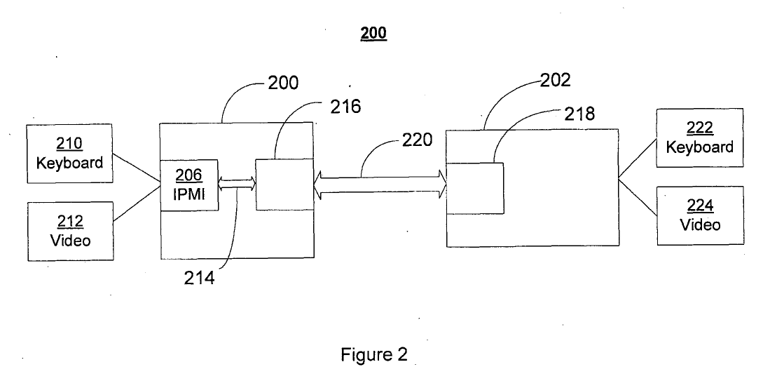

FIG. 2 is exemplary system 200 configured to manage a target computer. Shown are target computer 200 and managing computer 202. Managing computer 218 is configured in a manner similar to managing computer 102 of FIG. 1. Target computer 200 is in a boot up cycle. Executing on target computer 200 is BIOS management application 216 and IPMI 206. IPMI receives input signals from exemplary devices keyboard 210 and video 212. IPMI 206 converts the input signals to internet protocol format and provides the converted signals to BIOS management application 216 through communication link 214 to be transmitted to managing computer 202. After receipt at managing computer 202, the converted signals may then be displayed on video device 224.

To provide a means of controlling target computer 200, command signals from keyboard 222 may be converted and transmitted to target computer 200 through communication link 220. The signals may be converted by IPMI 206 and displayed on video device 212. The signals may also be data signals to control target computer 200 during the boot up cycle. Thus, communication link 220 may be bi-directional.

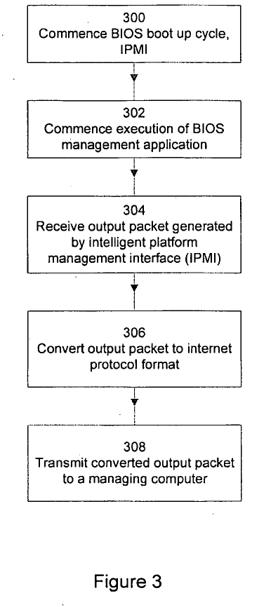

FIG. 3 provides an exemplary method of managing a target computer during the boot up cycle. The boot up cycle is commenced at step 300, which in some examples, means that the target computer BIOS commences execution. Further, in some examples, a target computer may be configured to provide for an additional interface, such as an IPMI. Once the BIOS commences execution, a BIOS management application commences execution at step 302. The BIOS management application, among other things, coordinates communications between a target computer and a managing computer.

An output packet is generated by the IPMI 304. This output packet may be a signal received from one or more devices, such as the target computer itself, the motherboard, a keyboard, or other devices not listed. The IPMI converts at step 306 the output packet into an appropriate communication format. If the system is configured to communicate through the internet, a TCP/IP format may be used. If the system is configured to communicate through a serial input/output port, the appropriate communication for that I/O port may be used. Once the output packet is converted, the output packet is then transmitted at step 308 to a managing computer in communication with the target computer.

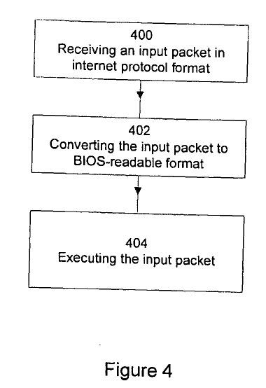

The target computer may also receive command signals to provide for the ability to control the target computer from a managing computer. FIG. 4 is an exemplary method of controlling a target computer during a BIOS boot up cycle. The target computer receives at step 400 the input packet in a particular communication format. For example, if the target computer is configured to communicate with the managing computer through the internet, the format may be an internet protocol format, or TCP/IP. The input packet is converted at step 402 to BIOS-readable format and executed at step 404.

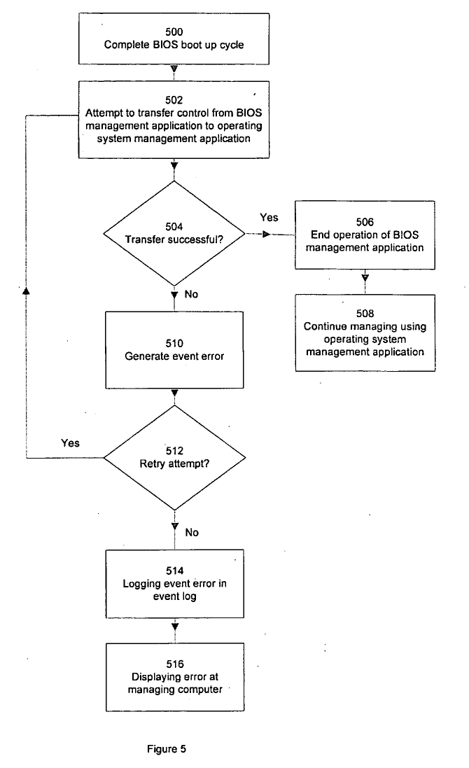

Once target computer 200 has completed a boot up cycle, target computer 200 operating system commences execution. Thus, to continue monitoring of target computer, through the boot up cycle to steady state, or operating, condition, the BIOS management application 216 may hand over control to a steady state managing application, such as managing application 124 of FIG. 1. FIG. 5 is an exemplary and non-limiting method of transferring control from a BIOS management application to an operating system management application.

The boot up cycle has completed at step 500. The BIOS management application attempts at step 502 to transfer control from to an operating system management application. If the transfer is successful at step 504, the BIOS management application operation is ended at step 506 and the managing of the target computer is continued at step 508 through the use of the operating system management application.

If the attempt to transfer control is unsuccessful at step 504, an event error at step 510 may be generated and received at a managing computer. The target computer may be configured to retry at step 512 the attempt at step 502 to transfer control, or the managing computer may be configured to transmit a control signal to the target computer to retry at step 512 the attempt at step 502 to transfer control. If no retry of the attempt to transfer control is to occur, the event error may be logged into an event log at step 514 and displayed at step 516 at the managing computer. If there is to be another attempt at transferring control, the attempt is made again at step 502. It should be understood that the event log may also include non-error events.

### Exemplary Boot Up Cycle Phase

When a user wants to access a target computer or non-computer, such as, but not limited to, a serial console(s), a power distribution unit(s), or a network router(s), the user utilizes the user computer control software (UCCS) to request access to a target computer or non-computer. UCCS will send the access request to a management computer control software (MCCS). The MCCS will approve or not approve UCCS's request. If the request is approved, then the MCCS will send the approval with the appropriate information back to UCCS. The MCCS sends the appropriate approval information to the target computer or non-computer. UCCS will notify the user that access has been approved. If the request is not approved, then the MCCS will send not approved to UCCS. UCCS will notify the user that access has not been approved.

After the target computer or non-computer receives the approved request's appropriate information, the computer or non-computer will send the appropriate information to UCCS to start communications. UCCS will notify the user that communications has been established with the requested target computer or non-computer. The user will communicate with the target computer or non-computer through UCCS to the appropriate software and/or firmware resident in the target computer or non-computer. During these processes, the MCCS records the appropriate information.

When the user no longer desires to communicate with the target computer or non-computer, the user will enter a stop communications command to UCCS. The user entered data can be generated by a variety of devices, including but not limited to a keyboard, a mouse, and a stylus with a digital tablet. UCCS will send “stop communications information” to the MCCS and the target computer or non-computer. UCCS will stop communications with the target computer or non-computer. The computer or non-computer will stop communicating with UCCS. During these processes, the MCCS records the appropriate information.

When a computer or non-computer begins its boot up cycle, the booting target computer or non-computer sends “start of boot up information” to a MCCS utilizing the booting target computer's target computer control software (TCCS) or the booting non-computer's internal notification and communication method. The MCCS informs appropriate UCCS's that the booting computer or non-computer is booting up. UCCS will start its booting computer or non-computer process(es). UCCS will notify the user that the booting computer or non-computer is booting up. If the user is allowed and chooses to communicate with the booting computer or non-computer, the user will enter data for the booting computer or non-computer through UCCS.

The user entered data can be generated by a variety of devices, including but not limited to a keyboard, a mouse, and a stylus with a digital tablet. UCCS will send the entered data to the MCCS. The MCCS will send the data to the booting computer or non-computer for the appropriate action(s) by the booting computer or non-computer. When the booting computer or non-computer completes its boot up process(es), it notifies the MCCS that its boot up process(es) are complete. The MCCS will send the appropriate information to appropriate UCCS's that the target computer or non-computer has completed its boot process(es). MCCS and UCCS's make the appropriate changes in their communication method(s) with the booting computer or non-computer. UCCS notifies the user that the booting computer or non-computer has completed its boot up process(es). The user will take any desired and authorized action with the booting computer or non-computer in the same manner that the user uses when the user requests access to a target computer or non-computer in its post boot up process(es). During these process(es), the MCCS records the appropriate information.

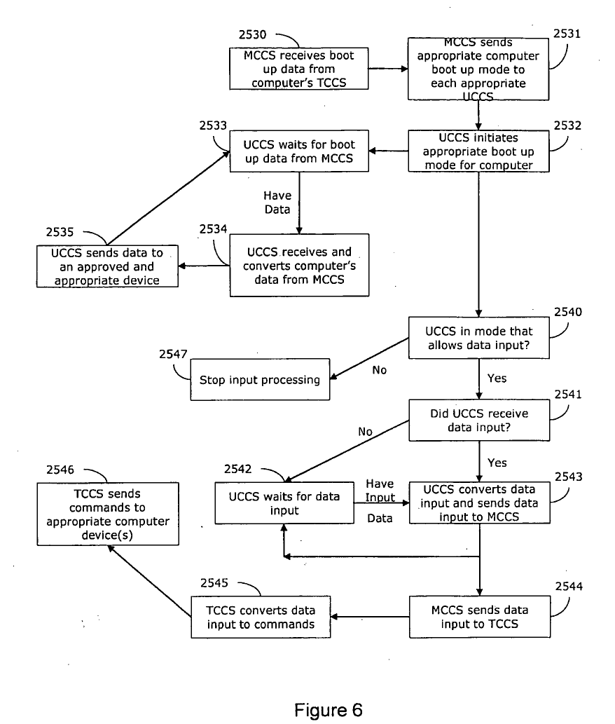

FIG. 6 is an exemplary method of the present subject matter describing a communication link during the boot up cycle. In particular, FIG. 6 illustrates how the MCCS and UCCS communicate with the TCCS during the target computer's boot up process(es). The MCCS receives 2530 boot up data from the target computer's TCCS. The MCCS then sends 2531 the appropriate computer boot up mode information to appropriate UCCS. The mode may include but is not limited to management, monitoring, sensing and others. The UCCS initiates 2532 its appropriate target computer boot up mode. As part of step 2532, UCCS may start step 2533 and step 2540. The UCCS waits 2533 for boot up data from MCCS. Also, the UCCS may receive 2534 and converts the target computer's data.

The UCCS transmits 2535 the data to an approved and appropriate device. An appropriate device may include but is not limited to a LCD panel and a laser printer. The UCCS checks 2540 to see if data input is allowed. If data input is allowed, then step 2541 commences. If data output is not allowed, then step 2547 starts. The UCCS tests 2541 for data input has been received. If data input has been received, then step 2543 starts. If data input has not been received, then step 2542 starts. In step 2543, the UCCS converts the data input and sends the data input to the MCCS. After item 2543 completes, step 2542 commences in which the UCCS resumes waiting for data input. The MCCS sends 2544 the data input to the TCCS. The UCCS waits at step 2542 for data input. When data input is received by UCCS, step 2543 starts. In step 2545, the TCCS converts the data input to commands for the appropriate computer device(s). Computer device(s) may include, but is not limited to ROM chip(s), processor chip(s), and disk drive(s). In step 2546, the TCCS sends the commands to the appropriate computer device(s). In step 2547, the UCCS stops data input processing.

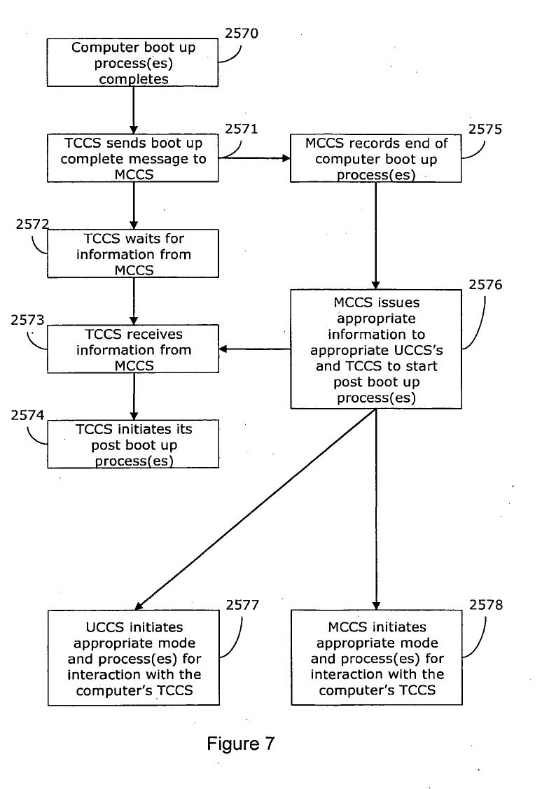

FIG. 7 is an exemplary method illustration how TCCS, MCCS and UCCS may change their process(es) at the end of the target computer's boot up process(es). At step 2570, a target computer completes its boot up process(es). At step 2571, the TCCS informs the MCCS that the boot up process(es) are complete. At step 2572, the TCCS waits for the appropriate information from the MCCS. At step 2573, the TCCS receives the information from the MCCS. At step 2574, the TCCS initiates its post boot up process(es).

At step 2575, the MCCS records the target computer has completed its boot up process(es). At step 2576, the MCCS issues the appropriate information to appropriate UCCS's and the target computer's TCCS. At step 2577, the UCCS initiates the appropriate mode of interaction with the target computer's TCCS and initiates its appropriate process(es). At step 2578, the MCCS initiates the appropriate mode of interaction with the target computer's TCCS and initiates its appropriate process(es).

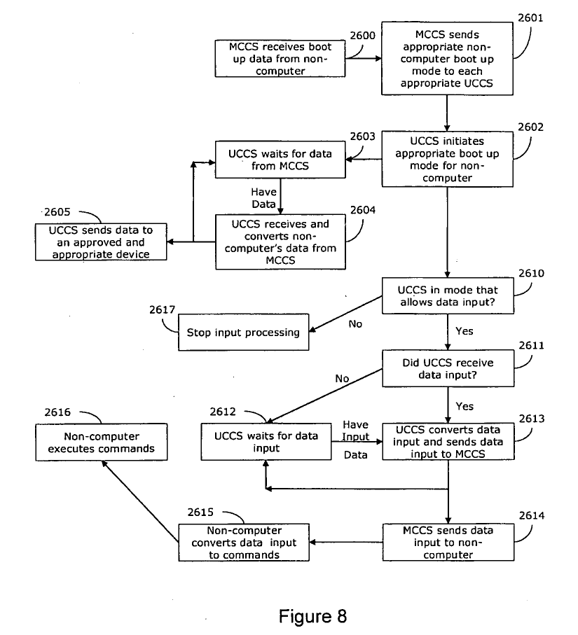

FIG. 8 illustrates how the MCCS and UCCS communicate with a target non-computer during its boot up process(es). At step 2600, the MCCS receives boot up data from the target non-computer. At step 2601, the MCCS sends the appropriate target non-computer boot up mode information to an appropriate UCCS. The mode may include but is not limited to management, monitoring, and sensing. At step 2602, the UCCS initiates appropriate target non-computer boot up mode. As part of step 2602, the UCCS may start step 2603 and step 2610. At step 2603, the UCCS waits for data from MCCS. When boot up data is received, step 2604 starts. At step 2604, the UCCS receives and converts the target non-computer's data. When step 2604 is complete, step 2603 resumes. At step 2605, the UCCS transmits the data to an approved and appropriate device. An appropriate device may include but is not limited to a LCD panel or a laser printer.

At step 2610, the UCCS checks to see if data input is allowed. If data input is allowed, then step 2611 starts. If data output is not allowed, then step 2617 starts. At step 2611, the UCCS checks to see if data input has been received. If data input has been received, then step 2613 starts. If data input has not been received, then step 2612 starts. At step 2612, the UCCS waits for data input. When data input is received by UCCS, step 2613 starts. At step 2613, the UCCS converts the data input and sends the data input to the MCCS. After step 2613 is complete, at step 2612, the UCCS resumes waiting for data input. At step 2614, the MCCS sends the data input to the non-computer. At step 2615, the non-computer converts the data input to commands. At step 2616, the non-computer executes the commands. At step 2617, the UCCS stops data input processing.

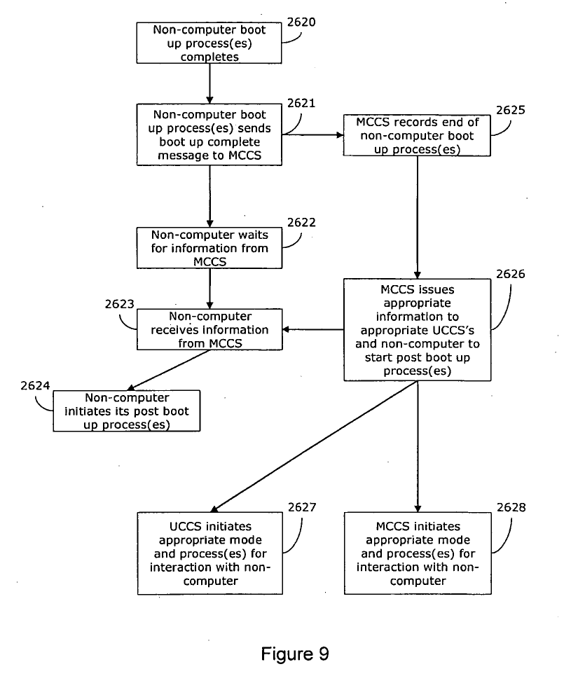

FIG. 9 illustrates how MCCS and UCCS change their communication process(es) with the target non-computer at the end of its boot up process(es). At step 2620, the target non-computer completes its boot up process(es). At step 2621, the non-computer informs the MCCS that the boot up process(es) are complete. At step 2622, the non-computer waits for the appropriate information from the MCCS. At step 2623, the non-computer receives the information from the MCCS. At step 2624, the non-computer initiates its post boot up process(es).

At step 2625, the MCCS records the target non-computer has completed its boot up process(es). At step 2626, the MCCS issues the appropriate information to appropriate UCCS's and the target non-computer to initiate their respective post boot up process(es). At step 2267, the UCCS initiates the appropriate mode of interaction with the target non-computer and initiates its appropriate process(es). At step 2628, the MCCS initiates the appropriate mode of interaction with the target non-computer and initiates its appropriate process(es).

### Exemplary Post-Boot Up Cycle (Steady State or Operational) Phase

When a user wants to access a target computer or non-computer (including but not limited to serial consoles, power distribution units, and network routers), the user utilizes the user computer control software (UCCS) to request access to a target computer or non-computer. UCCS will send the access request to a management computer control software (MCCS). The MCCS will approve or not approve UCCS's request. If the request is approved, then the MCCS will send the approval with the appropriate information back to UCCS. The MCCS sends the appropriate approval information to the target computer or non-computer. UCCS will notify the user that access has been approved.

If the request is not approved, then the MCCS will send “not approved” to UCCS. UCCS will notify the user that access has not been approved. After the target computer or non-computer receives the approved request's appropriate information, the computer or non-computer will send the appropriate information to UCCS to start communications. UCCS will notify the user that communications has been established with the requested target computer or non-computer. The user will communicate with the target computer or non-computer through UCCS to the appropriate software and/or firmware resident in the target computer or non-computer. During these processes, the MCCS records the appropriate information.

When the user no longer desires to communicate with the target computer or non-computer, the user will enter a stop communications command to UCCS. The user entered data can be generated by a variety of devices, including but not limited to a keyboard, a mouse, and a stylus with a digital tablet. UCCS will send stop communications information to the MCCS and the target computer or non-computer. UCCS will stop communications with the target computer or non-computer. The computer or non-computer will stop communicating with UCCS. During these processes, the MCCS records the appropriate information.

When a computer or non-computer begins its boot up cycle, the booting target computer or non-computer sends start of boot up information to a MCCS utilizing the booting target computer's target computer control software (TCCS) or the booting non-computer's internal notification and communication method. The MCCS informs appropriate UCCS's that the booting computer or non-computer is booting up. UCCS will start its booting computer or non-computer process(es). UCCS will notify the user that the booting computer or non-computer is booting up. If the user is allowed and chooses to communicate with the booting computer or non-computer, the user will enter data for the booting computer or non-computer through UCCS.

The user entered data can be generated by a variety of devices, including but not limited to a keyboard, a mouse, and a stylus with a digital tablet. UCCS will send the entered data to the MCCS. The MCCS will send the data to the booting computer or non-computer for the appropriate action(s) by the booting computer or non-computer. When the booting computer or non-computer completes its boot up process(es), it notifies the MCCS that its boot up process(es) are complete. The MCCS will send the appropriate information to appropriate UCCS's that the target computer or non-computer has completed its boot process(es). MCCS and UCCS's make the appropriate changes in their communication method(s) with the booting computer or non-computer. UCCS notifies the user that the booting computer or non-computer has completed its boot up process(es). The user will take any desired and authorized action with the booting computer or non-computer in the same manner that the user uses when the user requests access to a target computer or non-computer in its post boot up process(es). During these process(es), the MCCS records the appropriate information.

In some examples, a user may access one or more computers and/or non-computers simultaneously through UCCS. A target computer or non-computer can be accessed by one or more users simultaneously through the MCCS and/or the TCCS. All communication links between MCCS, UCCS, TCCS, computer, and/or non-computer are bi-directional. All communication links between MCCS, UCCS, TCCS, computer, and/or non-computer may be a variety of methods, including but not limited to a TCP/IP compatible network and a serial data stream. Multiple UCCS's can be executing on the same or different computers.

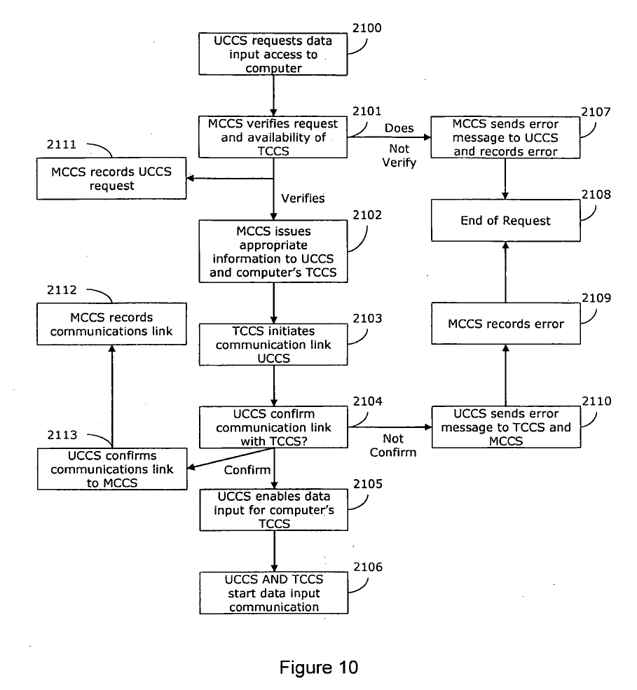

FIG. 10 illustrates how a UCCS establishes data input access to a target computer that is in its post boot up process(es). At step 2100, a user uses a UCCS to request data input access to a target computer. At step 2101, the MCCS verifies the data input request and the availability of the target computer's TCCS. If the request and availability do verify, then step 2102 starts. If the request and/or availability do not verify, then step 2107 starts. At step 2102, the MCCS issues the appropriate information to UCCS and to the target computer's TCCS to establish a data input access mode.

At step 2103, the TCCS initiates communication with UCCS. At step 2104, the UCCS confirms that communication has been established with the target computer's TCCS. If communications is confirmed, then steps 2105 and 2113 are started. If communications is not confirmed, then step 2110 is started. At step 2105, the UCCS enables the user to enter output data to send to the target computer. The output can be generated by a variety of devices, including but not limited to a keyboard, a mouse, and a stylus with a digital tablet. At step 2106, the UCCS and the TCCS start data input mode communication. At step 2107, the MCCS sends an error message to UCCS and records the error.

At step 2108, the data input access request ends. At step 2110, the UCCS sends an error message to the MCCS and the TCCS. At step 2109, the MCCS records the error. At step 2111, the MCCS records UCCS's access request. At step 2113, the UCCS confirms the communication link to the MCCS. At step 2112, the MCCS records that a communication link is established between UCCS and the target computer.

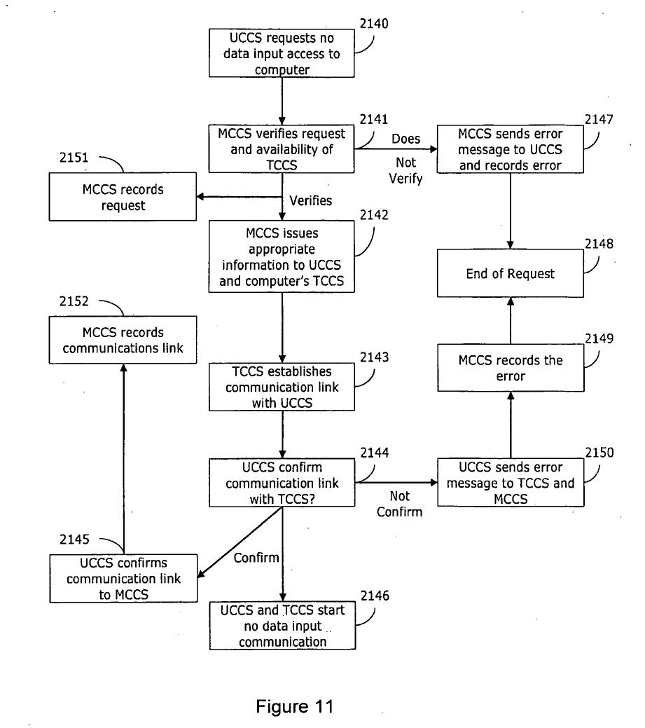

FIG. 11 illustrates how UCCS establishes no data input access to a target computer that is in its post boot up process(es). At step 2140, a user uses a UCCS to request no data input access to a target computer. At step 2141, the MCCS verifies the no data input request and the availability of the target computer's TCCS. If the request and availability do verify, then step 2142 starts. If the request and/or availability do not verify, then step 2147 starts. At step 2142, the MCCS issues the appropriate information to UCCS and to the target computer's TCCS to establish a no data input access.

At step 2143, the TCCS establishes communication with UCCS. At step 2144, the UCCS confirms that a communication link has been established with the target computer's TCCS. If a communication link is confirmed, then steps 2145 and 2146 are started. If a communications link is not confirmed, step 2150 is started. At step 2145, the UCCS confirms the communications link with the TCCS to the MCCS. At step 2146, the UCCS and TCCS start no data input communication. At step 2147, the MCCS sends an error message to UCCS and records the error. At step 2148, the no data input access request ends. At step 2150, the UCCS sends an error message to the MCCS and the TCCS. At step 2149, the MCCS records the error. At step 2151, the MCCS records the UCCS's access request. At step 2152, the MCCS records that a communication link is established between UCCS and the target computer.

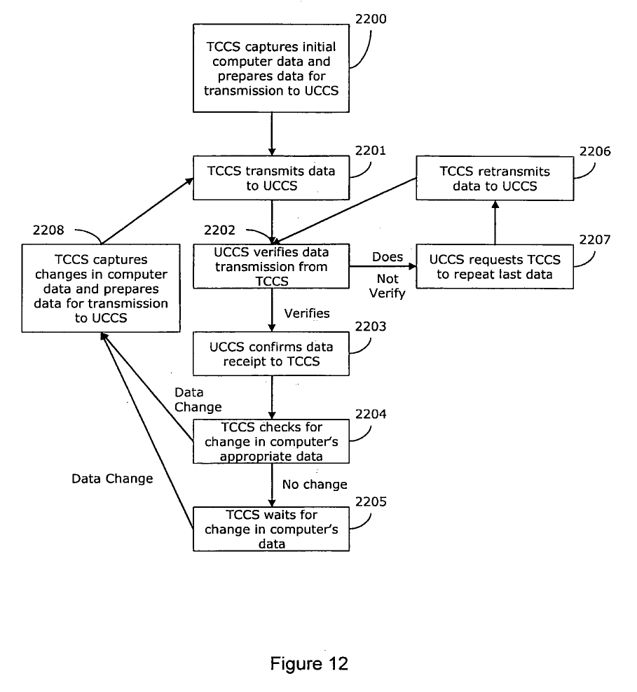

FIG. 12 illustrates how the TCCS prepares the target computer's data output for transmission to UCCS in the target computer's post boot up process(es). At step 2200, the TCCS captures the target computer's initial data response to UCCS request for access and prepares the data for transmission to UCCS. At step 2201, the TCCS transmits the data to UCCS. At step 2202, the UCCS verifies the data transmission. If the data verifies, then step 2203 starts. If the data does not verify, then step 2207 starts. At step 2203, the UCCS confirms receipt of the data to the TCCS.

At step 2204, the TCCS checks for change in the target computer's appropriate data. If the target computer's appropriate data has changed, then step 2208 starts. If the target computer's appropriate data has not changed, then step 2205 starts. At step 2205, the TCCS waits for a change in the target computer's data. When a change occurs in the target computer's appropriate data, then step 2008 starts. At step 2207, the UCCS requests the TCCS retransmit the last data. At step 2206, the TCCS retransmits the data. At step 2208, the TCCS captures changes in the target computer's appropriate data and prepares the data for transmission.

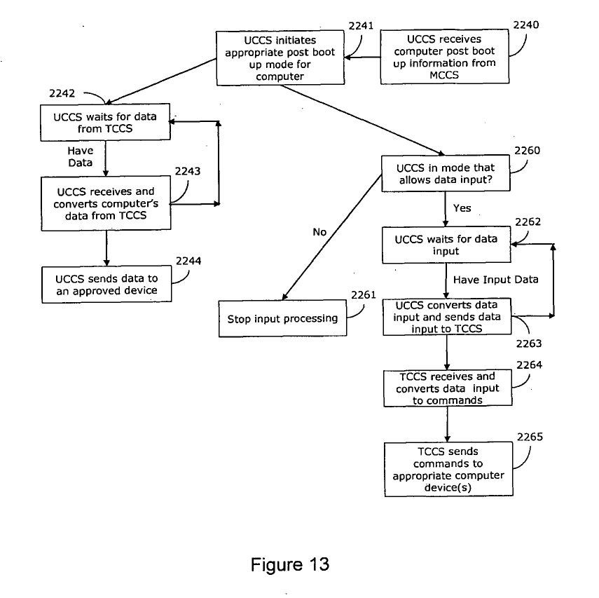

FIG. 13 illustrates how the MCCS and UCCS communicate with the TCCS during the target computer's post boot up process(es). At step 2240, the UCCS receives post boot up information from the MCCS. At step 2241, the UCCS initiates the appropriate post target computer boot up mode and process(es). The mode may include but is not limited to management, monitoring, and sensing. As part of step 2241, UCCS starts step 2242 and step 2260. At step 2242, the UCCS waits for data from the target computer's TCCS. At step 2243, the UCCS receives and converts the data from the target computer's TCCS.

After step 2243 completes receiving the data, step 2242 resumes. At step 2244, the UCCS sends the converted data to an approved device. The device may include but is not limited to LCD panel, laser printer, and speaker. At step 2260, the UCCS checks to see if data input is allowed. If data input is allowed, then step 2262 starts. If data output is not allowed, then step 2261 starts. At step 2261, the UCCS stops processing for data input for the target computer. At step 2262, the UCCS waits for data input to send to the target computer. When data input is received, then step 2263 starts. After step 2263 completes, step 2262 resumes. At step 2263, the UCCS converts the data input and sends the data input to the TCCS. At step 2264, the TCCS receives and converts the data input to commands for the appropriate target computer device(s). Computer device(s) may include, but is not limited to ROM chip(s), processor chip(s), and disk drive(s). At step 2265, the TCCS sends the commands to the appropriate target computer device(s).

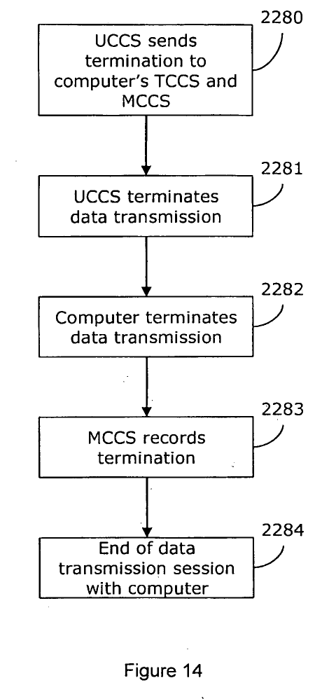

FIG. 14 illustrates how UCCS terminates communication with the target computer. At step 2280, the UCCS sends the terminate communication information to the target computer's TCCS and the MCCS. At step 2281, the UCCS terminates communication with the target computer. At step 2282, the target computer terminates communication with UCCS. At step 2283, the MCCS records the communication termination. At step 2284, the communication session with the target computer ends.

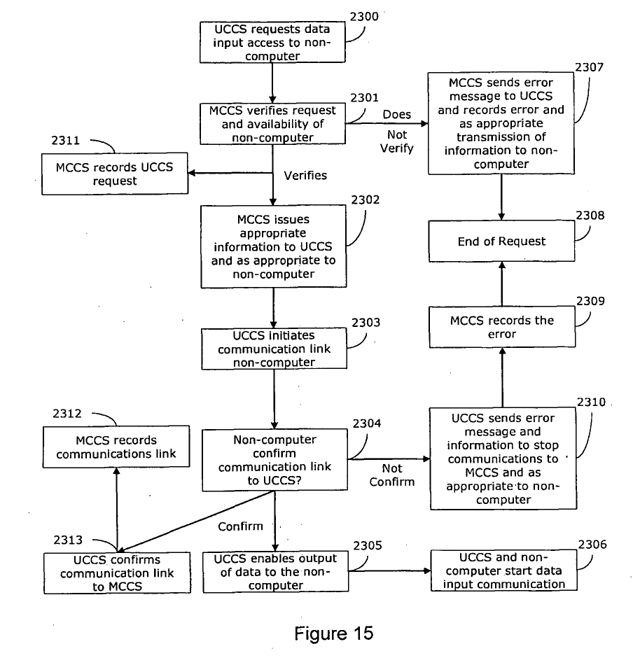

FIG. 15 illustrates how UCCS establishes data input access to a target non-computer that is in its post boot up process(es). At step 2300, the UCCS requests data input access to a target non-computer. At step 2301, the MCCS verifies the data input request and the availability of the target non-computer. If the request and availability do verify, then step 2302 starts. If the request and/or availability do not verify, then step 2307 starts. At step 2302, the MCCS issues the appropriate information to UCCS and as appropriate to the target non-computer to establish a data input access mode. At step 2303, the UCCS initiates communication with the target non-computer.

At step 2304, the non-computer confirms communication with UCCS. If communications is confirmed, then steps 2305 and 2313 are started. If communications is not confirmed, step 2310 is started. At step 2305, the UCCS enables output of data to the target non-computer. The data output can be generated by a variety of devices, including but not limited to a keyboard, a mouse, and a stylus with a digital tablet. At step 2306, the UCCS and non-computer start data input mode communication. At step 2307, the MCCS sends an error message to UCCS; records the error; and may send information to the non-computer.

At step 2308, the data input access request ends. At step 2310, the UCCS sends an error message to the MCCS, and as appropriate to the non-computer, to terminate all communication between UCCS and the non-computer. At step 2309, the MCCS records the error. At step 2311, the MCCS records the UCCS's access request. At step 2313, the UCCS confirms that the communication link is established with the non-computer to the MCCS. At step 2312, the MCCS records that a communication link is established between UCCS and the target non-computer.

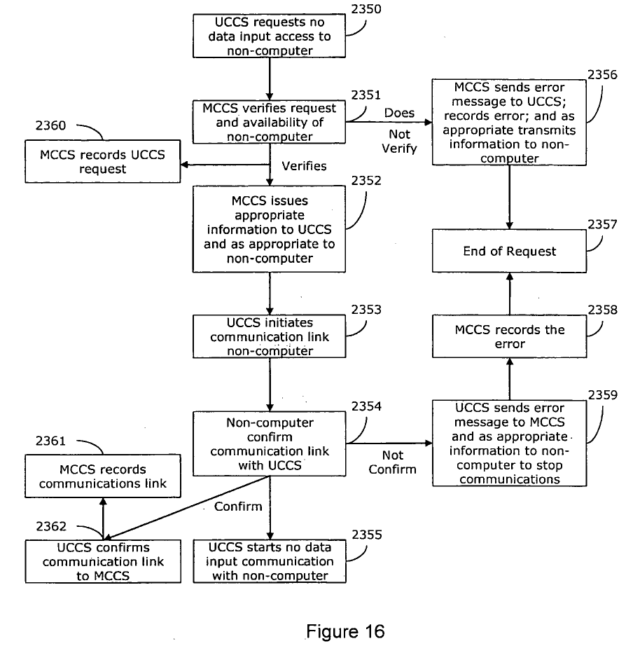

FIG. 16 illustrates how UCCS establishes “no data input access” to a target non-computer that is in its post boot up process(es). At step 2350, the UCCS requests no data input access to a target non-computer. At step 2351, the MCCS verifies the no data input request and the availability of the target non-computer. If the request and availability do verify, then step 2352 starts. If the request and/or availability do not verify, then step 2356 starts. At step 2352, the MCCS issues the appropriate information to UCCS and as appropriate to the target non-computer. At step 2353, the UCCS initiates communication with the target non-computer.

At step 2354, the non-computer confirms the communications link with UCCS. If communications is confirmed, then steps 2355 and 2362 are started. If communications is not confirmed, the step 2359 is started. At step 2355, the UCCS starts no data input communication with the non-computer. At step 2356, the MCCS sends an error message to UCCS; records the error; and as appropriate sends information to the non-computer. At step 2357, the no data input access request ends. At step 2359, the UCCS sends an error message to the MCCS, and as appropriate to the non-computer, with appropriate information to terminate all communication between UCCS and the non-computer. At step 2358, the MCCS records the error. At step 2360, the MCCS records the UCCS's access request. At step 2362, the UCCS confirms the communication link with the non-computer to the MCCS. At step 2361, the MCCS records that a communication link is established between UCCS and the target non-computer.

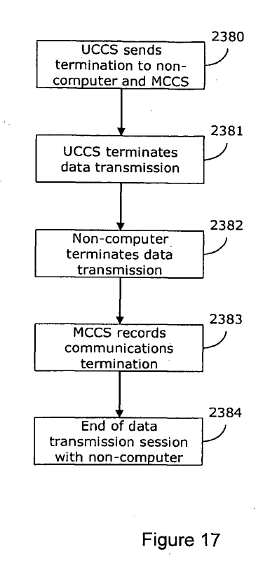

FIG. 17 illustrates how UCCS terminates communication with the target non-computer that is in its post boot up process(es). At step 2380, the UCCS sends the terminate communication information to the target non-computer and the MCCS. At step 2381, the UCCS terminates communication with the target non-computer. At step 2382, the target non-computer terminates communication with UCCS. At step 2383, the MCCS records the communication termination. At step 2384, the communication session with the target non-computer ends.

It should be noted that the various techniques described herein can be implemented in connection with hardware or software or, where appropriate, with a combination of both. Thus, the methods and apparatus of the presently disclosed subject matter, or certain aspects or portions thereof, can take the form of program code (i.e., instructions) embodied in tangible storage media, such as floppy diskettes, CD-ROMs, hard drives, or any other machine-readable storage medium, where, when the program code is loaded into and executed by a machine, such as a computer, the machine becomes an apparatus for practicing the subject matter.

It should also be noted that, in the case of program code execution on programmable computers, the computer or computing device can generally include a processor, a storage medium readable by the processor (including volatile and non-volatile memory and/or storage elements), at least one input device, and at least one output device. One or more programs that can utilize the creation and/or implementation of domain-specific programming models aspects of the present invention, e.g., through the use of a data processing application programming interface (API) or the like, are preferably implemented in a high level procedural or object oriented programming language to communicate with a computer system. However, the program(s) can be implemented in assembly or machine language, if desired. In any case, the language can be a compiled or interpreted language, and combined.

Finally, while the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A method for managing a target computer's video output and keyboard input at a managing computer, comprising:
commencing a BIOS boot up cycle, wherein the BIOS boot up cycle comprises the initiation of an intelligent platform management interface;
commencing execution of a BIOS management application during the BIOS boot up cycle;
receiving, at the management application, an output packet generated by the intelligent platform management interface, wherein the output packet is in BIOS-readable format;
converting the output packet into an internet protocol format; and
transmitting the converted output packet to the managing computer.

2. The method of claim 1, wherein the output packet is related to a video output, a sensor data, or a keyboard input.

3. The method of claim 2, wherein the sensor data is a temperature or a fan speed.

4. The method of claim 1, further comprising:
receiving, at the managing computer, the converted output packet;
converting the output packet to a video output; and
displaying the video output at the managing computer.

5. The method of claim 1, further comprising:
receiving, at the intelligent platform management interface of the target computer, an input packet in internet protocol format, wherein the input packet comprises an input generated at the managing computer;
converting the input packet to BIOS-readable format; and
initiating the input packet at the target computer.

6. The method of claim 5, wherein the input is received from a device configured to receive a user entry.

7. The method of claim 6, wherein the device is a keyboard, a digital pad, or a device configured to generate a command from a voice input.

8. The method of claim 1, further comprising attempting to transfer control to a operating system management application once the BIOS boot up cycle is complete.

9. The method of claim 8, further comprising determining whether control was successfully transferred to the operating system management application.

10. The method of claim 9, further comprising ending operation of the BIOS management application if the control was successfully transferred to the operating system management application.

11. The method of claim 9, further comprising sending an error message to the managing computer if the control was not successfully transferred to the operating system management application.

12. The method of claim 11, further comprising logging an error message in an event log.

13. The method of claim 12, further comprising displaying the error message at the managing computer.

14. A target system configured for remote management by a managing computer during a BIOS boot up cycle of a target computer, the system comprising:
a processor;
a device configured to provide an output to an intelligent platform management interface;
a computer-readable storage medium having instructions stored thereon which when executed, cause the processor to:
commence a BIOS boot up cycle, wherein the BIOS boot up cycle comprises the initiation of the intelligent platform management interface;
commence execution of a BIOS management application during the BIOS boot up cycle;
receive, at the management application, an output packet generated by the intelligent platform management interface, wherein the output packet is in BIOS-readable format; and
convert the output packet into an internet protocol format; and
an output port for transmitting the converted output packet to the managing computer.

15. The target system of claim 14, wherein the output packet is related to a video output, a sensor data, or a keyboard input.

16. The target system of claim 15, wherein the sensor data is a temperature or a fan speed.

17. The target system of claim 14, wherein the device is a non-computer or the target computer.

18. The target system of claim 14, further comprising:
an input communication port for receiving, at the intelligent platform management interface of the target computer, an input packet in internet protocol format, wherein the input packet comprises an input generated at the managing computer.

19. The target system of claim 18, wherein the input is generated through the use of a keyboard or a digital pad with a stylus.

20. The target system of claim 18, wherein the computer-readable storage medium has instructions stored thereon which when executed, cause the processor to:
convert the input packet to BIOS-readable format;
initiate the input packet at the target computer.

21. The target system of claim 14, wherein the computer-readable storage medium has instructions stored thereon which when executed, cause the processor to attempt to transfer control to a operating system management application once the BIOS boot up cycle is complete.

22. The target system of claim 14, wherein the computer-readable storage medium has instructions stored thereon which when executed, cause the processor to determine whether control was successfully transferred to the operating system management application.

23. The target system of claim 14, wherein the computer-readable storage medium has instructions stored thereon which when executed, cause the processor to end operation of the BIOS management application if the control was successfully transferred to the operating system management application.

24. The target system of claim 14, wherein the computer-readable storage medium has instructions stored thereon which when executed, cause the processor to send an error message to the managing computer if the control was not successfully transferred to the operating system management application.

25. The target system of claim 24, wherein the error message is logged in an event log, wherein the error message is displayed at the managing computer.

26. The target system of claim 14, wherein the output port for transmitting the converted output packet is further configured to transmit the converted output packet to a plurality of second managing computers.

27. One or more managing computers configured to manage video output commands from a target computer, comprising:
an input module configured to receive an output packet from the target computer in an internet protocol format, wherein the output packet was generated, at the target computer by:
commencing a BIOS boot up cycle, wherein the BIOS boot up cycle comprises the initiation of an intelligent platform management interface;
commencing execution of a BIOS management application during the BIOS boot up cycle;
receiving, at the management application, an output packet generated by the intelligent platform management interface, wherein the output packet is in internet protocol format; and receiving keyboard input for transmission to the target computer,
converting the keyboard input packet into an internet protocol format; and
an output module configured to transmit to the target computer an input packet, wherein the input packet comprises a keyboard command, wherein the input packet is in internet protocol format.

28. The one or more managing computers of claim 27, wherein the output packet is related to a video output, a sensor data, or a keyboard input.

29. The one or more managing computers of claim 28, wherein the sensor data is a temperature or a fan speed.

30. The one or more managing computers of claim 27, further comprising a display configured to display the output packet.

31. The one or more managing computers of claim 27, further comprising a keyboard configured to generate the keyboard command.
